(19) United States
(12) Patent Application Publication
(10) Pub. No.: US 2022/0397412 A1
(43) Pub. Date: Dec. 15, 2022

(54) CONTROL METHOD AND CONTROL SYSTEM OF MOBILE DEVICE

(71) Applicants: HYUNDAI MOTOR COMPANY, Seoul (KR); KIA CORPORATION, Seoul (KR)

(72) Inventors: Jae Yul WOO, Seoul (KR); Soobin KIM, Seoul (KR); Seunghyun WOO, Seoul (KR); Rowoon AN, Seoul (KR)

(73) Assignees: Hyundai Motor Company, Seoul (KR); KIA CORPORATION, Seoul (KR)

(21) Appl. No.: 17/828,439

(22) Filed: May 31, 2022

(30) Foreign Application Priority Data
Jun. 14, 2021 (KR) 10-2021-0076590

(51) Int. Cl. G01C 21/36; G01C 21/00

(52) U.S. Cl. CPC G01C 21/3638; G01C 21/3644; G01C 21/3885

(57) ABSTRACT

A control method and control system of a mobile device perform a route guidance and POI guidance using a POI database for a commercial navigation and a POI database for AR, and enable seamless transition between commercial navigation services and AR services by removing the dependency of data through data exchange between the POI database for commercial navigation and the POI database for AR. The control method includes receiving a selection of destination; executing one of a first route guidance mode based on non-AR and a second route guidance mode based on AR, based on the selected destination; and providing a route guidance service based on AR by switching from the first route guidance mode to the second route guidance mode, in response to that a remaining distance or remaining time from a location of the mobile device to the selected destination approaches within a predetermined distance or predetermined time.

### CROSS-REFERENCE TO RELATED APPLICATION(S)

This application claims the benefit of priority to Korean Patent Application No. 10-2021-0076590, filed on Jun. 14, 2021, the disclosure of which is incorporated herein by reference.

### TECHNICAL FIELD

The disclosure relates to a point of interest (P01) guidance, and more particularly, to a guidance of a pre-registered POI through a mobile device.

### BACKGROUND

Augmented reality (AR) is a technology that shows a single image by superimposing a two-dimensional (2D) or three-dimensional (3D) virtual world image on an image of the real world. AR, a concept that complements the real world with the virtual world, uses a virtual environment created with computer graphics, but the main is a real environment. Computer graphics serve to provide additional information necessary for the real environment. By superimposing the 3D virtual image on the actual image viewed by a user, the distinction between the real environment and the virtual screen is blurred. AR technology, in which the real environment and virtual objects are combined, allows users to see the real environment, providing better realism and additional information. For example, when the surroundings are captured with a camera provided in a mobile device (e.g., a cell phone), information such as the location of a building or structure in the image captured by the camera and a registered phone number are displayed together in the image.

One example of services utilizing AR is to guide a route to a destination, and to inform users of the location of the destination by displaying an anchor on the destination of an image when the destination is reached.

The information disclosed in the Background section above is to aid in the understanding of the background of the disclosure, and should not be taken as acknowledgement that this information forms any part of prior art.

### SUMMARY

An aspect of the disclosure is to perform a route guidance and POI guidance using a POI database for a commercial navigation and a POI database for AR, and is to enable seamless transition between commercial navigation services and AR services by removing the dependency of data through data exchange between the POI database for commercial navigation and the POI database for AR.

Additional aspects of the disclosure will be set forth in part in the description which follows and, in part, will be obvious from the description, or may be learned by practice of the disclosure.

According to an aspect of the disclosure, a control method of a mobile device may include the steps of receiving a selection of destination; executing any one of a first route guidance mode based on non-Augmented Reality (non-AR) and a second route guidance mode based on Augmented Reality (AR), based on the selected destination; and providing a route guidance service based on AR by switching from the first route guidance mode to the second route guidance mode, in response to that a remaining distance or remaining time from a location of the mobile device to the selected destination approaches within a predetermined distance or predetermined time.

The first route guidance mode may be a route guidance mode based on a commercial navigation service.

The control method may further include receiving data necessary for the first route guidance mode from a first database in the first route guidance mode; and receiving data necessary for the second route guidance mode from the first database and a second database in the second route guidance mode. The first database may provide data for the first route guidance mode and the second database may provide data for the second route guidance mode.

The control method may further include a step of in addition to a state where the remaining distance or remaining time to the selected destination approaches within the predetermined distance or predetermined time, providing the route guidance service based on AR by switching from the first route guidance mode to the second route guidance mode if an AR environment is built around the destination.

The control method may further include maintaining the first route guidance mode before the remaining distance or remaining time to the selected destination approaches within the predetermined distance or predetermined time.

The second route guidance mode may be executed in a background while running the first route guidance mode.

The control method may further include in response to entering a global positioning system (GPS) shadow area where a GPS signal reception is impossible, searching for an AR environment built based on GPS to provide the route guidance service.

According to another aspect of the disclosure, a control system of a mobile device may include a mobile device configured to receive data from a first database for a first route guidance mode based on non-Augmented Reality (non-AR), receive data from a second database for a second route guidance mode based on Augmented Reality (AR), and execute one of the first route guidance mode based on non-AR and the second route guidance mode based on AR, based on a selection of destination. In response to that a remaining distance or remaining time from a location of the mobile device to the selected destination approaches within a predetermined distance or predetermined time, the mobile device may switch from the first route guidance mode to the second route guidance mode to provide a route guidance service based on AR.

The first route guidance mode may be a route guidance mode based on a commercial navigation service.

The mobile device may receive data necessary for the first route guidance mode from the first database in the first route guidance mode; and receive data necessary for the second route guidance mode from the first database and the second database in the second route guidance mode.

The control system, in addition to a state where the remaining distance or remaining time to the selected destination approaches within the predetermined distance or predetermined time, may include the mobile device provides the route guidance service based on AR by switching from the first route guidance mode to the second route guidance mode if an AR environment is built around the destination.

The mobile device may maintain the first route guidance mode before the remaining distance or remaining time to the selected destination approaches within the predetermined distance or predetermined time.

The second route guidance mode may be executed in a background while running the first route guidance mode.

In response to entering a global positioning system (GPS) shadow area where a GPS signal reception is impossible, the mobile device may search for an AR environment built based on GPS to provide the route guidance service.

According to another aspect of the disclosure, a control method of a mobile device may include the steps of receiving a selection of destination; executing one of a first route guidance mode based on non-Augmented Reality (non-AR) and a second route guidance mode based on Augmented Reality (AR), based on the selected destination; providing a route guidance service based on AR by switching from the first route guidance mode to the second route guidance mode in response to that a remaining distance or remaining time from a location of the mobile device to the selected destination approaches within a predetermined distance or predetermined time or if an AR environment is built around the destination; and maintaining the first route guidance mode in response to that before the remaining distance or remaining time to the selected destination approaches within the predetermined distance or predetermined time or if the AR environment is not built around the destination.

According to another aspect of the disclosure, a control system of a mobile device may include a mobile device configured to receive data from a first database for a first route guidance mode based on non-Augmented Reality (non-AR), receive data from a second database for a second route guidance mode based on Augmented Reality (AR), execute any one of the first route guidance mode based on non-AR and the second route guidance mode based on AR, based on a selected destination, provide a route guidance service based on AR by switching from the first route guidance mode to the second route guidance mode in response to that a remaining distance or remaining time from a location of the mobile device to the selected destination approaches within a predetermined distance or predetermined time or if an AR environment is built around the destination, and maintain the first route guidance mode in response to that before the remaining distance or remaining time to the selected destination approaches within the predetermined distance or predetermined time or if the AR environment is not built around the destination.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a view illustrating a control system of a mobile device according to an exemplary embodiment of the disclosure; and

FIG. 2 is a view illustrating a method of controlling a mobile device according to an exemplary embodiment of the disclosure.

### DETAILED DESCRIPTION

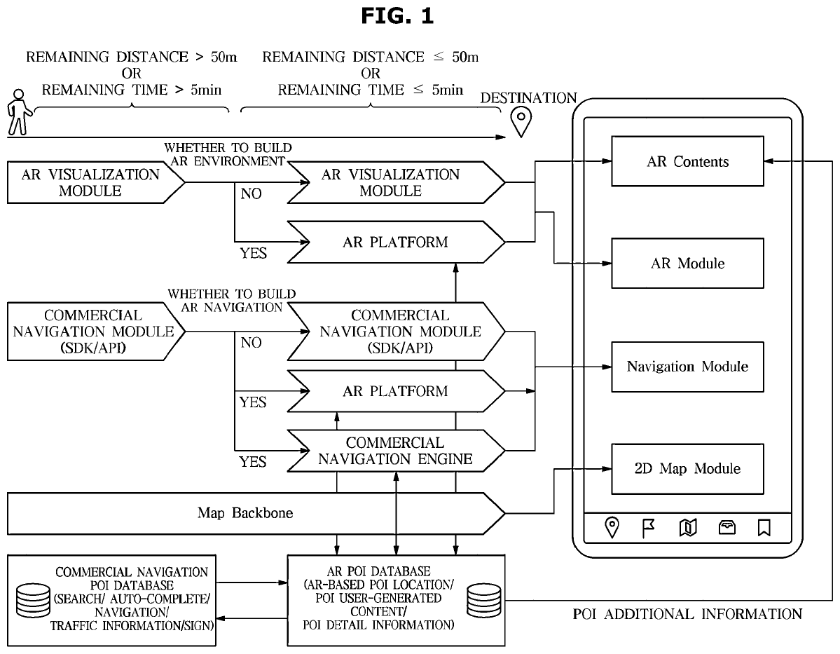

FIG. 1 is a view illustrating a control system of a mobile device according to an exemplary embodiment of the disclosure. The mobile device according to an exemplary embodiment of the disclosure provides an augmented reality (AR) service based on AR environment, and also provides a general commercial navigation service. Herein, the general commercial navigation service refers to a navigation service that is not based on the AR environment.

The mobile device according to the exemplary embodiment of the disclosure enables a user to receive both the commercial navigation service and the AR service through mutual switching between the commercial navigation service and the AR service during a route guidance to a destination. To this end, the mobile device according to the exemplary embodiment of the disclosure is provided with a POI database for commercial navigation and a POI database for AR separately, but enables seamless mutual switching between commercial navigation services and AR services by removing a dependency of data through data exchange between the POI database for commercial navigation and the POI database for AR. Herein, POI refers to a Point of Interest.

In the mobile device according to the exemplary embodiment of the disclosure, when a predetermined condition is satisfied, the user's convenience is promoted by automatically switching between the commercial navigation services and the AR services without user's intervention. Herein, the predetermined condition may include, for example, a case in which a remaining distance to the destination is less than or equal to a predetermined distance, or a remaining time to reach the destination is less than or equal to a predetermined time.

As shown in FIG. 1, in the mobile device according to the exemplary embodiment of the disclosure, a commercial navigation service provision section and an AR service provision section are divided based on the remaining distance or remaining time from a current location to the destination. In FIG. 1, when the remaining distance to the destination exceeds the predetermined distance (e.g., 50 m) or the remaining time to reach the destination exceeds the predetermined time (e.g., 5 min), the commercial navigation services are provided in a foreground. At this time, the AR services are running in a background.

As such, in a state where the commercial navigation services are executed in the foreground of the user's mobile device and the AR services are running in the background thereof, the user carrying the mobile device approaches the destination further, and thus when the remaining distance from the current location to the destination approaches the predetermined distance (e.g., 50 m) or less or the remaining time to reach the destination approaches the predetermined time (e.g., 5 min) or less, a route guidance mode of the mobile device is switched from the commercial navigation services to the AR services to provide a reality-based route guidance service.

However, even if the user approaches the predetermined distance or the predetermined time or less near the destination, any one of maintenance of the commercial navigation services, switching to the AR services, and mixing of the commercial navigation services and the AR services may be optionally taken depending on whether the AR environment is built near the destination.

For example, when the AR environment near the destination is built, a route guidance service environment of the mobile device is switched from the commercial navigation services to the AR services and the AR services are provided from the foreground through an AR platform, in response to the user arriving near the destination. At this time, the POI database for AR is used for the route guidance based on the AR services. If necessary, data that does not exist in the POI database for AR but exists in the POI database for commercial navigation is secured through collaboration with the POI database for commercial navigation, leading to be used for route guidance based on AR service.

Accordingly, the mobile device according to the exemplary embodiment of the disclosure utilizes the POI database for commercial navigation and the POI database for AR for the route guidance (or POI guidance), but to avoid duplication (or to minimize duplication) of data stored in the POI database for commercial navigation and the POI database for AR, respectively, the POI data for commercial navigation and the POI data for AR are separately stored, and collaboration is made through mutual data exchange if necessary. For example, the POI database for commercial navigation stores route data and POI data that are generally provided to navigation services, and the POI database for AR stores data specific to the AR environment (e.g., user-participation data). As such, by storing unique data in each of the POI database for commercial navigation and the POI database for AR and performing free transition between the commercial navigation services and the AR services based on route guidance conditions, the mobile device according to the exemplary embodiment of the disclosure may freely utilize the data stored in each of the POI database for commercial navigation and the POI database for AR.

To this end, the POI database for commercial navigation may store search history data, auto complete data, route guidance data, traffic information data, and traffic sign data. Furthermore, the POI database for AR may store AR-based POI location data, POI user-generated content, and POI detail information. The POI database for commercial navigation and the POI database for AR may be provided by itself in the mobile device, or may be separately provided in a remote server. When provided in the remote server, the POI database for commercial navigation and the POI database for AR may communicate with the mobile device via a wireless communication.

Conversely, if the AR environment near the destination is not built, the commercial navigation services currently in service is maintained in response to the user arriving near the destination.

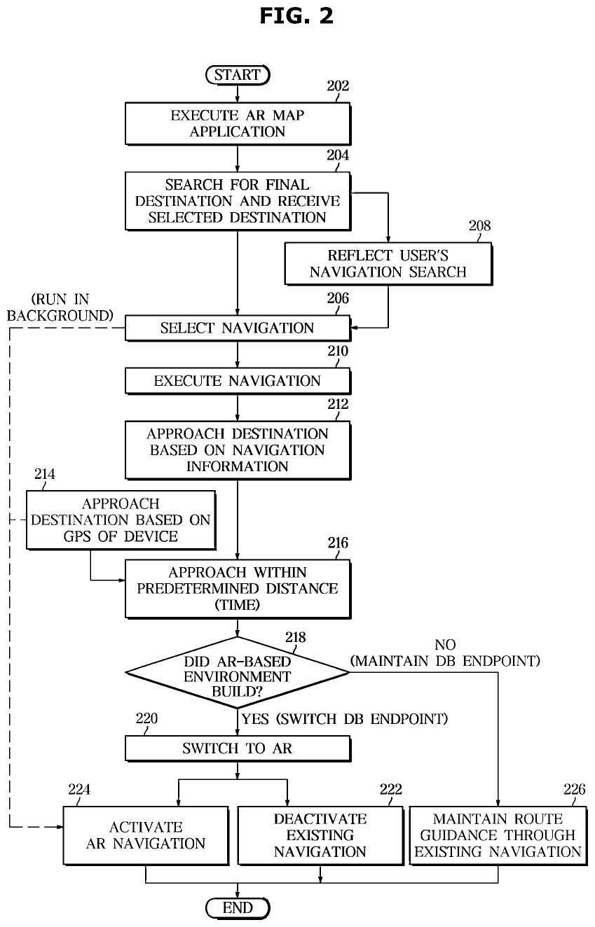

FIG. 2 is a view illustrating a method of controlling a mobile device according to an exemplary embodiment of the disclosure.

As shown in FIG. 2, an AR map application may be executed in the mobile device by the user's manipulation (e.g., selection) (202).

The user of the mobile device may search for and select a final destination on the executed application, and the mobile device receives the result of a user's destination selection (204).

After receiving the selected destination of users result in 204, a navigation to be performed is selected based on the received user selection (206). At this time, the mobile device may reflect the user's navigation search result in the navigation selection (208). If the destination selected by the user is located within the predetermined distance (time) from the current location, the AR services are executed to provide the route and POI guidance services based on AR. Conversely, if the destination selected by the user is located outside the predetermined distance (time) from the current location, the commercial navigation services are performed to start the general commercial navigation mode.

When the destination selection and navigation selection are completed, the navigation is executed based on the selected results (210). In FIG. 2, it is assumed that the commercial navigation services run in the foreground and the AR services run in the background. The user may move towards the destination while carrying the mobile device with the navigation running.

The mobile device may determine how close the mobile device approaches the destination as the user moves while carrying the mobile device (212 and 214). A method of determining how close the user approaches the destination in the mobile device may be a method 212 based on navigation information and a method 214 based on global positioning system (GPS) information.

The mobile device, through the operation 212 based on the navigation information and the operation 214 based on the GPS information, monitors whether the user approaches within the predetermined distance (e.g., 50 m) from the destination or the user approaches the remaining time to reach the destination or less the predetermined time (e.g., 5 min) (216). When the user carrying the mobile device approaches within the predetermined distance (time) from the destination, it is determined whether the environment for providing the AR-based guidance services is built at the corresponding location (i.e., around the destination) (218).

If the environment for providing the AR-based guidance services is built around the destination (YES in 218), the mobile device switches to the AR service mode (220). To this end, in the mobile device, the existing commercial navigation service mode activated on the foreground is deactivated (222), and the AR service mode running in the background is activated on the foreground (224). At this time, the POI database for AR is used for the route guidance based on the AR services, but if necessary, the data that does not exist in the POI database for AR but exists in the POI database for commercial navigation is secured through collaboration with the POI database for commercial navigation, resulting in utilizing the AR-based route guidance.

In 218 of FIG. 2, if the environment for providing an AR-based guidance services is not built around the destination (No in 218), the mobile device maintains the commercial navigation services running in the foreground as it is (226). Even if the user approaches within the predetermined distance (time) near the destination, if the AR environment has been not built around the destination, information to provide based on AR does not exist, so switching to the AR service mode in the mobile device is unnecessary and thus keeping the existing commercial navigation service mode as it stands is more preferable.

If the area where the mobile device is located is a GPS shaded area where GPS signal reception is impossible, the mobile device preferentially searches for AR environment based on GPS, and if the AR environment based on GPS has been established, the route guidance service based on the GPS may be provided through the AR environment.

The above embodiments are described based on a mobile device. The mobile device may include a cell phone, a computer, or the like, the present disclosure, however, is not limited thereto. The mobile device may include a vehicle or the like.

In one example, the disclosed embodiments may be implemented in the form of a non-transitory computer-readable recording medium storing software, instructions, or algorithm. The mobile device may include a processor and the non-transitory computer-readable recording medium storing the software, instructions, or algorithm. When the software, instructions, or algorithm is executed by the processor 25 (or the mobile device), the processor (or the mobile device) may be configured to perform the above-described functions or operations. The computer-readable recording medium includes various kinds of recording media such as a hard disk drive (HDD), a solid state drive (SSD), a silicon disc drive (SDD), read-only memory (ROM), random-access memory (RAM), CD-ROM, magnetic tapes, floppy disks, optical data storage devices, and the like.

As is apparent from the above, according to the exemplary embodiments of the disclosure may perform the route guidance and the POI guidance using the POI database for the commercial navigation and the POI database for AR, but enable seamless transition between commercial navigation services and AR services by removing the dependency of data through data exchange between the POI database for commercial navigation and the POI database for AR.

Exemplary embodiments of the disclosure have thus far been described with reference to the accompanying drawings. It should be apparent to those of ordinary skill in the art that the disclosure may be practiced in other forms than the exemplary embodiments as described above without changing the technical idea or essential features of the disclosure. The above exemplary embodiments are only by way of example, and should not be interpreted in a limited sense.

What is claimed is:

1. A control method of a mobile device, the control method comprising:
receiving a selection of a destination;
executing one of a first route guidance mode based on non-Augmented Reality (non-AR) and a second route guidance mode based on Augmented Reality (AR), based on the selected destination; and
providing a route guidance service based on AR by switching from the first route guidance mode to the second route guidance mode, in response to that a remaining distance or remaining time from a location of the mobile device to the selected destination approaches within a predetermined distance or predetermined time.

2. The control method of claim 1, wherein the first route guidance mode is a route guidance mode based on a commercial navigation service.

3. The control method of claim 1, further comprising:
receiving data necessary for the first route guidance mode from a first database in the first route guidance mode;
receiving data necessary for the second route guidance mode from the first database and a second database in the second route guidance mode,
wherein the first database provides data for the first route guidance mode and the second database provides data for the second route guidance mode.

4. The control method of claim 1, further comprising:
in addition to a state where the remaining distance or remaining time to the selected destination approaches within the predetermined distance or predetermined time, providing the route guidance service based on AR by switching from the first route guidance mode to the second route guidance mode if an AR environment is built around the destination.

5. The control method of claim 1, further comprising:
maintaining the first route guidance mode before the remaining distance or remaining time to the selected destination approaches within the predetermined distance or predetermined time.

6. The control method of claim 1, wherein the second route guidance mode is executed in a background while running the first route guidance mode.

7. The control method of claim 1, further comprising:
in response to entering a global positioning system (GPS) shadow area where a GPS signal reception is impossible, searching for an AR environment built based on GPS to provide the route guidance service.

8. A control system of a mobile device, the control system comprising:
a mobile device configured to receive data from a first database for a first route guidance mode based on non-Augmented Reality (non-AR), receive data from a second database for a second route guidance mode based on Augmented Reality (AR), and execute one of the first route guidance mode based on non-AR and the second route guidance mode based on AR, based on a selection of destination;
wherein in response to that a remaining distance or remaining time from a location of the mobile device to the selected destination approaches within a predetermined distance or predetermined time, the mobile device is configured to switch from the first route guidance mode to the second route guidance mode to provide a route guidance service based on AR.

9. The control system of claim 8, wherein the first route guidance mode is a route guidance mode based on a commercial navigation service.

10. The control system of claim 8, wherein the mobile device is configured to receive data necessary for the first route guidance mode from the first database in the first route guidance mode, and receive data necessary for the second route guidance mode from the first database and the second database in the second route guidance mode.

11. The control system of claim 8, wherein
in addition to a state where the remaining distance or remaining time to the selected destination approaches within the predetermined distance or predetermined time, the mobile device is configured to provide the route guidance service based on AR by switching from the first route guidance mode to the second route guidance mode if an AR environment is built around the destination.

12. The control system of claim 8, wherein the mobile device is configured to maintain the first route guidance mode before the remaining distance or remaining time to the selected destination approaches within the predetermined distance or predetermined time.

13. The control system of claim 8, wherein the second route guidance mode is executed in a background while running the first route guidance mode.

14. The control system of claim 8, wherein
in response to entering a global positioning system (GPS) shadow area where a GPS signal reception is impossible, the mobile device is configured to search for an AR environment built based on GPS to provide the route guidance service.

15. A control method of a mobile device, the control method comprising:
receiving a selection of destination;
executing one of a first route guidance mode based on non-Augmented Reality (non-AR) and a second route guidance mode based on Augmented Reality (AR), based on the selected destination;
providing a route guidance service based on AR by switching from the first route guidance mode to the second route guidance mode in response to that a remaining distance or remaining time from a location of the mobile device to the selected destination approaches within a predetermined distance or predetermined time or if an AR environment is built around the destination; and
maintaining the first route guidance mode in response to that before the remaining distance or remaining time to the selected destination approaches within the predetermined distance or predetermined time or if the AR environment is not built around the destination.

16. A control system of a mobile device, the control system comprising:
a mobile device configured to:
receive data from a first database for a first route guidance mode based on non-Augmented Reality (non-AR),
receive data from a second database for a second route guidance mode based on Augmented Reality (AR),
execute one of the first route guidance mode based on non-AR and the second route guidance mode based on AR, based on a selection of destination,
provide a route guidance service based on AR by switching from the first route guidance mode to the second route guidance mode in response to that a remaining distance or remaining time from a location of the mobile device to the selected destination approaches within a predetermined distance or predetermined time or if an AR environment is built around the destination, and
maintain the first route guidance mode in response to that before the remaining distance or remaining time to the selected destination approaches within the predetermined distance or predetermined time or if the AR environment is not built around the destination.
